(19) United States
(12) Patent Application Publication
(10) Pub. No.: US 2005/0138302 A1
(43) Pub. Date: Jun. 23, 2005

(54) Method and apparatus for logic analyzer observability of buffered memory module links

(75) Inventors: John B. Lusk, Olympia, WA (US); Richard J. Glass, Olympia, WA (US); Ishfaqur Raza, Olympia, WA (US)

Correspondence Address: MARGER JOHNSON & McCOLLOM, P.C., 1030 SW Morrison Street, Portland, OR, 97205, US

(73) Assignee: Intel Corporation (a Delaware corporation), Santa Clara, CA (US)

(21) Appl. No.: 10/746,532

(22) Filed: Dec. 23, 2003

(51) Int. Cl. G06F 12/00

(52) U.S. Cl. 711/154

(57) ABSTRACT

Some embodiments of the invention maintain a high degree of overall logic analysis and debug capabilities while simultaneously enabling the reduction of logic analyzer design complexity. Other embodiments of the invention provide a logical analyzer interface (LAI) mode of operation to memory module buffers by adding additional LAI features to the silicon designed to also operate in a normal mode. Other embodiments of the invention are described in the claims.

### BACKGROUND OF THE INVENTION

1. Technical Field of the Invention

This disclosure relates generally to memory systems, components, and methods and more particularly to a method and apparatus for providing logic analyzer observability into a buffered memory channel, as well as providing selected logic analyzer functionalities.

2. Description of the Related Art

Digital processors, such as microprocessors, use a computer memory subsystem to store data and processor instructions. Some processors communicate directly with memory, and others use a dedicated controller chip, often part of a “chipset,” to communicate with memory.

Conventional computer memory subsystems are often implemented using memory modules. Referring to FIG. 1, a microprocessor 20 communicates with a memory controller/hub (MCH) 30 that couples the microprocessor 20 to various peripherals. One of these peripherals is system memory, shown as memory modules 40, 42, and 44 inserted in card slots 50, 52, and 54. When connected, the memory modules are addressed from MCH 30 whenever MCH 30 asserts appropriate signals on an Address/Control Bus 60. Data transfers between MCH 30 and one of memory modules 40, 42, and 44 occur on a Data Bus 70. Address/Control Bus 60 and Data Bus 70 are referred to as “multi-drop” buses, as they have more than two sets of devices (modules and MCH included) connected at different points of the bus.

Simulations have shown that for applications of 2 to 4 memory modules (in particular, dual inline memory modules, or DIMMs) per memory channel, similar multi-drop bus technology reaches a maximum bandwidth of 533-667 MT/s (mega-transactions/second), or 4.2-5.3 GB/s (gigabytes/second) for an eight byte wide DIMM. Achieving the next significant level, 800 megatransfers/second (MT/s) and beyond, will be difficult if not impossible with the multi-drop bus topology.

### BRIEF DESCRIPTION OF THE DRAWINGS

FIG. 1 illustrates a prior art computer memory subsystem.

FIG. 2 illustrates a buffered memory module subsystem utilizing dual inline memory modules (DIMMs) that may be used in conjunction with some embodiments of the invention.

FIGS. 3A and 3B illustrate one possible configuration for the DIMMs shown in FIG. 2.

FIG. 4 is a conceptual representation of a Logic Analyzer Interface (LAI) installed in an instrumented, buffered memory configuration according to some embodiments of the invention.

FIG. 5 is a functional block diagram illustrating a memory module buffer operating in LAI mode according to some embodiments of the invention.

FIG. 6 is a block diagram further illustrating the memory module buffer of FIG. 5 with LAI functionality added.

FIG. 7 is a physical illustration of a Logic Analyzer Interface (LAI) according to some embodiments of the invention.

### DETAILED DESCRIPTION OF THE INVENTION

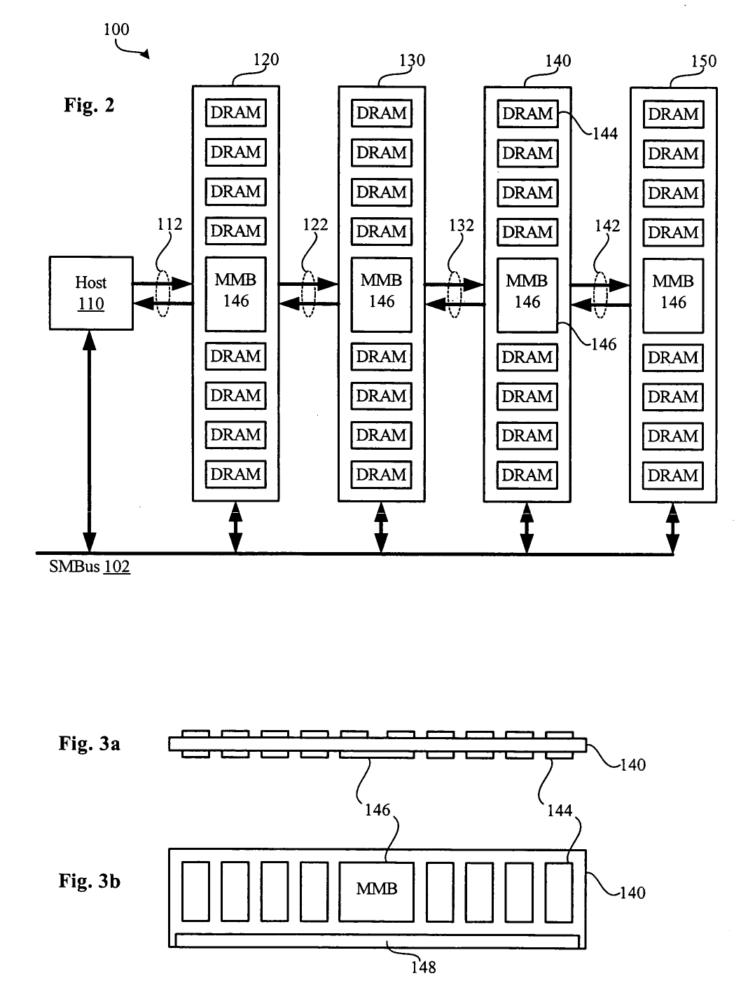

To overcome the obstacles for accommodating multiple memory modules at high transfer rates described above, a buffered memory module subsystem with a “point-to-point” topology has been proposed. FIG. 2 is a block diagram illustrating a buffered memory module subsystem utilizing DIMMs that may be used in conjunction with embodiments of the invention. It should be emphasized that embodiments of the invention are not limited only to memory module subsystems that utilize DIMMs. For example, embodiments of the invention work equally well with buffered memory module subsystems that utilize single inline memory modules, or SIMMs. Thus, the generic term “memory module” is intended to include DIMMs, SIMMs, and other memory devices that include a plurality of memory chips.

Referring to FIG. 2, a buffered memory module memory subsystem 100 is shown, including a host 110, four buffered memory modules 120, 130, 140, and 150, four memory channels 112, 122, 132, and 142, and a low-speed system management bus 102. Host 110 can include one or more microprocessors, signal processors, memory controllers, graphics processors, etc. Typically, a memory controller coordinates access to system RAM memory, and the memory controller will be the component of host 110 connected directly to the host memory channel 112, which is connected to the first buffered DIMM 120.

Buffered memory module 140 is typical of the memory modules. A memory module buffer (MMB) 146 connects module 140 to a host-side (upstream) memory channel 132 and to a downstream memory channel 142. A number of Dynamic Random Access Memory chips 144, or DRAMs 144 connect to memory module buffer 146 through a memory device bus (not shown in FIG. 2) to provide addressable read/write memory for subsystem 100. It should be emphasized that embodiments of the invention are not limited only to memory modules that include DRAMs. The memory modules in a buffered memory subsystem may include other types of memory chips besides DRAMs. For example, the memory chips may include SRAM (static RAM), SDRAM (Synchronous Dynamic RAM) or some other as yet undeveloped type of memory.

FIGS. 3A and 3B show one possible physical appearance for DIMM embodiments of memory module 140. A set of card edge connectors 148 provide electrical connections for upstream and downstream memory channels, reference voltages, clock signals, SMBus 102, etc. In this instance, MMB 146 is centrally located on one side of module 140, flanked on each side by four DRAM devices 144, with ten more DRAM devices 144 occupying the opposite side of module 140.

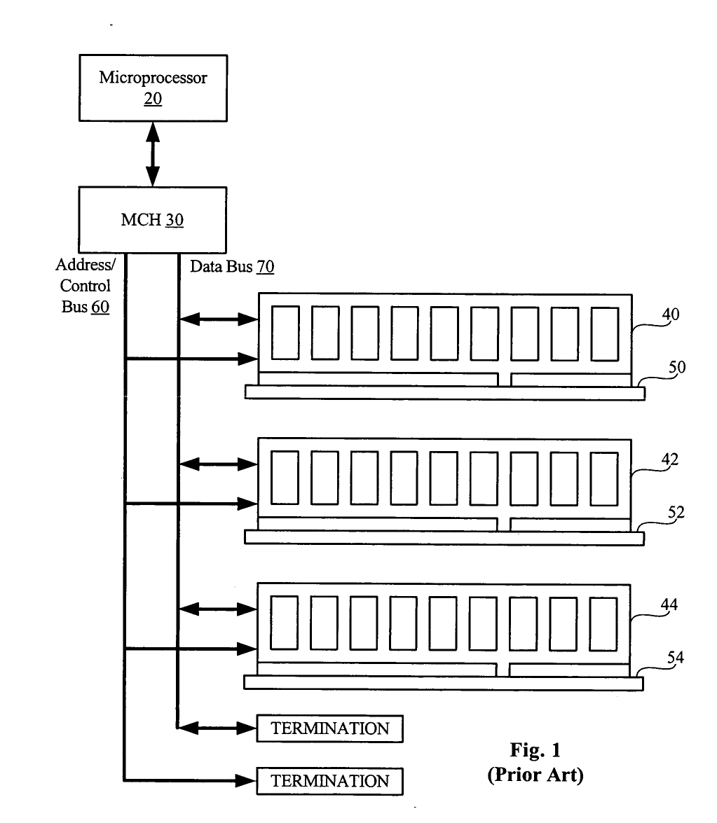

Each memory channel 112, 122, 132, and 142 in FIG. 2 is a point-to-point connection between two devices, either two MMBs 146 or the host 110 and an MMB 146. The direct connection allows the memory channels to run preferably at extremely high data rates, e.g., at speeds that would not be possible with a multi-drop bus that has a high capacitive loading and multiple stubs, such as the conventional memory subsystem of FIG. 1.

Although the buffered memory module subsystem 100 of FIG. 2 illustrates only MMBs 146 and a host 110, in alternative buffered memory module subsystems there may be a repeater (not shown) located between any two of the components illustrated in FIG. 2. For example, a repeater may be placed between the host 110 and the DIMM 120 or between the DIMM 120 and the DIMM 130.

Each of the memory channels 112, 122, 132, and 142 is composed of two uni-directional buses for data traffic in both directions. That is, commands and data can travel in the direction away from the host 110 and status and data can travel towards the host 110. For convenience, the movement of command and data through the memory channels in a direction away from the host 110 will henceforth be referred to as “southbound.” Likewise, movement of status and data through the memory channels in the direction toward the host 110 will be referred to “northbound.” It should be apparent that these terms have nothing to do with the actual geographic orientation of the memory channels.

The actual signal paths that make up the memory channels are implemented using high-speed serial differential signals. The number of differential signals in the southbound direction may be different than the number of signals in the northbound direction.

In normal mode of operation, host 110 accesses the memory space of module 140 by sending a commands and data, addressed to memory module 140, southbound on host memory channel 112. The MMB 146 of buffered memory module 120 receives the commands/data and resends it on memory channel 122 to the MMB 146 of buffered memory module 130. The MMB 146 of buffered memory module 130 next receives the command and resends it on memory channel 132 to MMB 146 of buffered memory module 140. On module 140, MMB 146 detects that the command is directed to it, decodes it, and transmits DRAM commands and signaling to the DRAMs (e.g., 144) controlled by that buffer. When a response is expected (such as when a read is requested), MMB 146 receives the data from the DRAMs, encodes/formats the data, and sends it backwards (northbound) along the memory channels 132, 122, and 112, repeated without modification by the MMBs 146 on modules 130 and 120, to host 110.

FIG. 2 also illustrates a control bus (SMBus 102) routed to the host 110 and to each of the buffered memory modules 120, 130, 140, and 150. Although proprietary or other standard buses or signaling may be used for other buffered memory module subsystems, an SMBus is illustrated in FIG. 2. A SMBus is a particular type of control bus that conforms to the System Management Bus (SMBus) Specification, SBS Implementers Forum, Version 2.0, Aug. 3, 2000. SMBus 102 provides a reliable low-speed (10 to 100 kbps) serial channel that is typically used in a computer to control peripherals such as a battery management system, fans, laptop display settings, memory module recognition and configuration, etc.

As in all memory subsystems, for validation and debug purposes it is extremely important to provide the ability to observe, record, and trigger on events in logical transactions across system interconnects. However, in the buffered memory module subsystem of FIG. 2, this poses some unique challenges.

Specifically, this challenge arises because, unlike the memory subsystem of FIG. 1, there is now a MMB 146 between the host 110 and the DRAMs 144. The memory device bus (not shown) between the MMB 146 and the DRAMs 144 on each memory module 120, 130, 140, 150 operates at significantly slower speeds than the memory channels 112, 122, 132, 142. For example, typical speeds for the memory channels 112, 122, 132, and 142 are on the order of 3 to 5 giga-transfers/second, while between the MMB 146 and the DRAMs it is demultiplexed to approximately 6 times slower for data and approximately 12 times slower for address and control signals. Conventional logic analyzers do not have the ability to directly probe signals at the same speeds as the memory channels 112, 122, 132, and 142. And even though the MMB to DRAM buses typically operate at much lower frequencies they are inaccessible to the logic analyzer since they are buried internal to the memory module board.

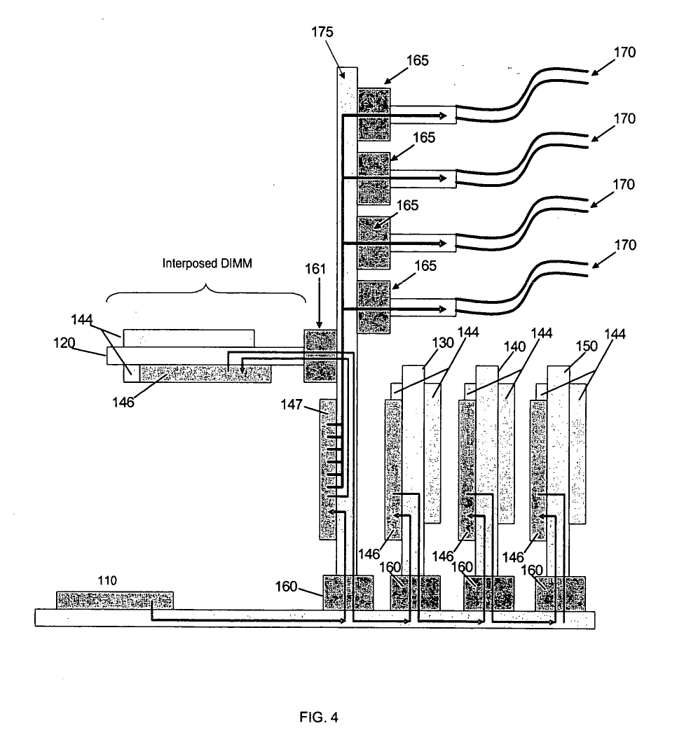

To provide a capability for solving these and/or similar problems, some embodiments of the invention provide a Logic Analyzer Interface (LAI) interposer assembly 175, as illustrated in FIG. 4. Referring to FIG. 4, the LAI 175 includes a single MMB 147 configured to operate in LAI mode, an upper connector 161 configured to receive the interposed DIMM 120, a number of probe sockets 165, and a card edge connector (which is not shown, because it is obscured by the first socket 160). However, this card edge connector is similar to the card edge connector 148 shown in FIG. 3B.

In FIG. 4, the LAI 175 is shown connected to the buffered memory module subsystem illustrated in FIG. 2. The LAI 175 is coupled with the socket 160 that would otherwise be occupied by DIMM 120 (see FIG. 2). The other DIMMs 130, 140, 150 remain connected to their corresponding sockets 160.

A DIMM 120 is inserted in the upper connector 161 that is located on the LAI 175. The DIMM 120 may also be referred to as the interposed DIMM 120. The upper connector 161 that attaches the interposed DIMM 120 to the LAI 175 is illustrated as a standard vertical connector, but alternate connector styles such as angled or straddle mount might be used to minimize possible physical interference problems. An LAI interposer assembly 175 may be installed in the first DIMM socket 160, as shown in FIG. 4. However, multiple interposers may also be installed in the other DIMM slots. Although not shown in FIG. 4, additional cables to provide LAI power, SMB programming, and cross-triggering between multiple LAIs 175 are also included on the LAI 175.

Standard logic analyzer high density probes 170 are attached to the LAI 175 with the probe sockets 165. During operation of the LAI 175, the MMB 147 included on the interposer operates in an LAI mode, while the other MMBs 146 on the interposed DIMM 120 and the DIMMs 130, 140, 150 operate in normal mode.

Attaching an interposed DIMM 120 to the LAI 175 is advantageous because the same number of normally operating MMBs 146 are available as when the LAI 175 is not installed to instrument the buffered memory module subsystem. The LAI 175 will be made to appear transparent to normal traffic on the memory channel.

For clarity, the arrows in FIG. 4 indicate only the southbound links (away from host 110), but the northbound links follow the same path in reverse. During LAI mode, the MMB 147 intercepts propagation of the southbound signals from the host 110. The data is buffered, and then retransmitted to the interposed DIMM 120, where the normally operating MMB 146 receives and processes the southbound commands/data in the same manner as if it were directly connected to the host 110 of the buffered memory module subsystem as shown in FIG. 2.

Conversely, the northbound data being sent from DIMM 130 arrives at interposed DIMM 120, which retransmits the data to the MMB 147. In other words, for the configuration shown in FIG. 4, the MMB 147 is the first to receive southbound data from the host 110 and the last to transmit northbound data to the host 110.

The northbound data in the MMB 147 operating in LAI mode is handled differently compared to the other MMBs 146 operating in normal (DRAM buffer) mode. In the normal mode the MMBs 146 capture, modify as necessary, and retransmit northbound data to the next component (MMB 146, MMB 147, repeater (not shown), or host 110) in the chain. However, the MMB 147 does not alter the content of the received northbound data before sending it northbound.

In addition to the operation described above, the MMB 147 operating in LAI mode may demultiplex and transmit southbound and northbound data at a reduced transfer rate to the probe sockets 165, where it is detected by the logic analyzer probes 170 for input to a logic analyzer mainframe.

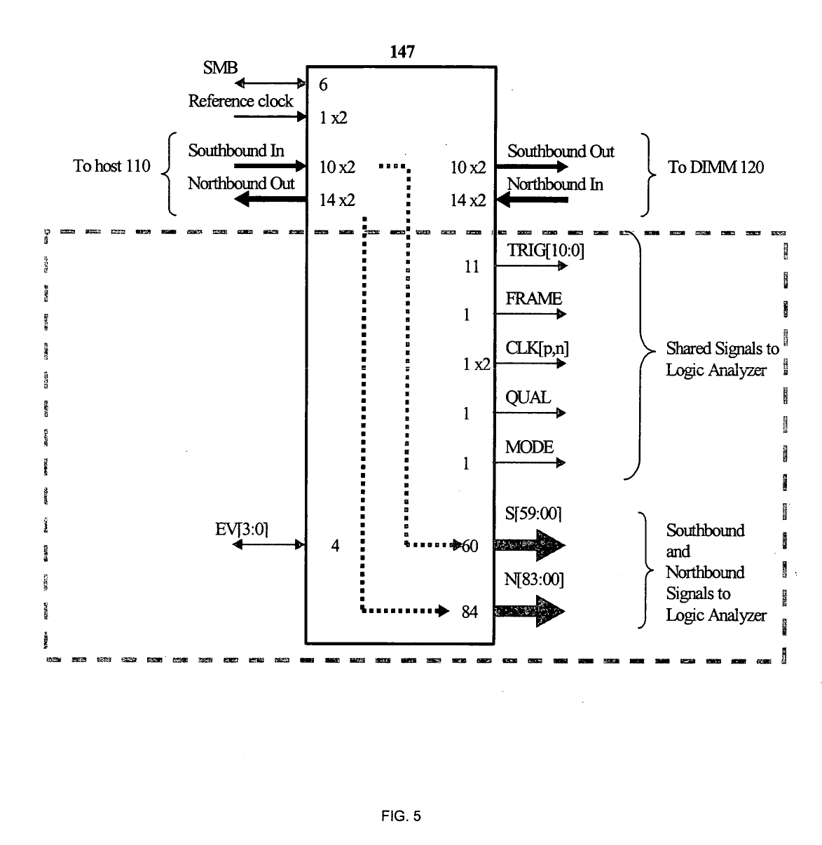

FIG. 5 is a functional diagram according to some embodiments of the invention. It illustrates signals such as the southbound and northbound data and the derived signals on the LAI mode MMB 147 shown in FIG. 4.

The signals shown outside of the dashed box represent links whose pin assignments in LAI mode for MMB 147 compared to DRAM buffer mode for the MMBs 146 of FIG. 4 remain unchanged. That is, the southbound links (composed of 10 differential signals) and the northbound links (composed of 14 differential signals) still remain connected to host 110 in the northbound direction and to the DIMM 120 in the southbound direction. In other embodiments of the invention, the number of southbound and northbound differential signals may be different. A differential reference clock signal and the SMB bus signals also remain in the same configuration as in the normal (DRAM buffer) mode.

The signals shown inside the dashed box represent signaling usages that have different connections in LAI mode for the MMB 147 as compared to the normal (DRAM buffer) mode for the MMBs 146 of FIG. 4. For example, in LAI mode there are 60 demultiplexed southbound signals S[59:00] and 84 demultiplexed northbound signals N[83:00] that in normal operation (such as in MMBs 146 of FIG. 4) are configured very differently and would be connected to the DRAMs 144 residing on each DIMM. In other embodiments of the invention, there may be a different number of demultiplexed northbound and southbound signals.

In LAI mode for MMB 147 the southbound and northbound signals are demultiplexed and transmitted by cables 170 to the attached logic analyzer at the same reduced transfer rate (as in normal mode) using the signals S[59:00] and N[83:00], respectively. The dotted arrows shown inside the MMB 147 represent this demultiplexing process. The DRAM differential signal CLK[p,n], is sent as is to the logic analyzer from MMB 147.

Furthermore, to be effective in analyzing the collected link traces, the data provided to the logic analyzer includes not only a demuxed link traffic, but also several derived signals. This information is derived by the MMB 147 and is represented by eleven trigger signals TRIG[10:0], the FRAME signal, the EV[3:0] signals, and the QUAL signal. In cases where multiple interposers 175 are attached to the buffered memory module subsystems, there is also a derived set of four shared signals EV[3:0] between the MMB 147s in the form of cross triggers. The EV[3:0] signals provide cross-triggering information with finer timing granularity than the logic analyzer can achieve acting alone. The FRAME signal indicates the beginning of a frame, as defined by the high speed protocol. The QUAL signal indicates filtering (qualified storage) opportunities. The TRIG[10:0] signals sends trigger signals to the logic analyzer to indicate a debug event in the high speed link. These are just some examples, other embodiments of the invention may provide other derived information to the logic analyzer. The MMB 147 also produces the signal MODE to indicate the training status of the high speed channel 112, 122, 132, 142, i.e. the link has gone through the initialization state where the training of the link is complete.

This ability to provide derived information to the logic analyzer is particularly advantageous. Critical logic analysis may now occur on the MMB 175, which could not be implemented in the logic analyzer itself. Therefore, despite the inability of logic analyzer designs to scale in performance to link debug complexity, the features in the MMB 147 affords a high degree of overall logic analysis and debug capabilities. The type of derived information described above are just a few examples, other embodiments of the invention may provide other derived information to the logic analyzer. Likewise, other embodiments of the invention may share more or fewer signals EV across multiple MMBs 147 when multiple LAIs 175 are attached to a memory system.

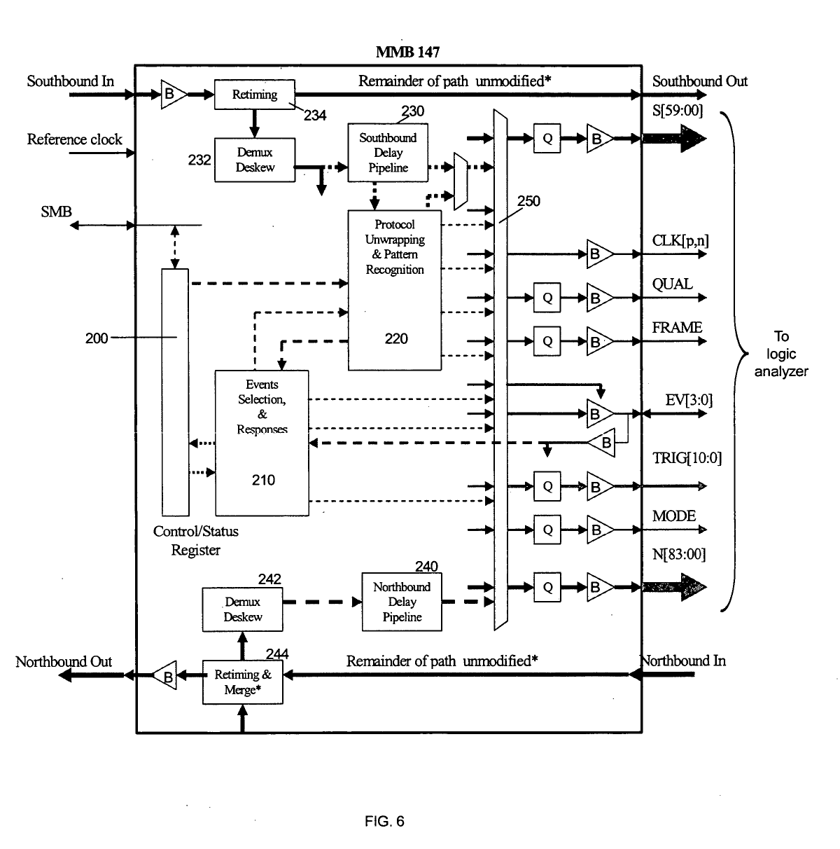

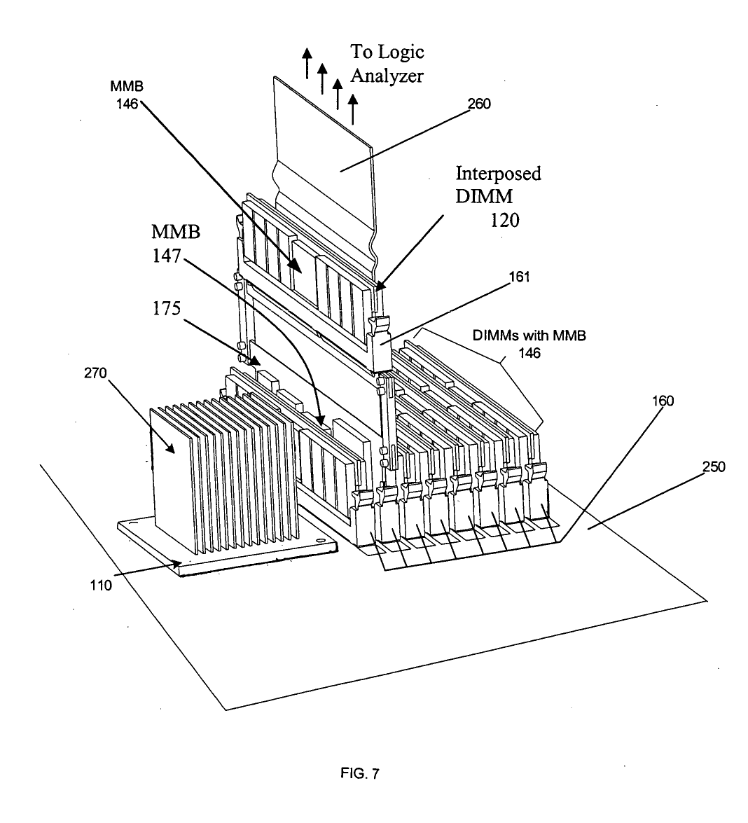

FIG. 6 is a functional block diagram that further illustrates the MMB 147 of FIG. 5 according to some embodiments of the invention. In FIG. 6, the components and signals illustrated by solid lines represents normal mode circuitry that is functional during both normal mode operation and LAI mode operation of the MMB 147. On the other hand, the components and signals illustrated with dashed lines represent LAI mode circuitry that is used only for LAI mode of operation. There are numerous solid arrows shown in FIG. 6 that do not have a complete connection indicated. In these cases, the connections are associated with other normal mode circuitry and are omitted to avoid obscuring these embodiments of the invention.

In FIG. 6, all external connections to the MMB 147 are the same as those illustrated in FIG. 5. All signals destined for the logic analyzer are buffered (by buffers B). All signals destined for the logic analyzer, except for the shared signals EV[3:0] and the differential clock signal CLK[p,n] are also latched (by latches Q). The select circuit 250 is configured to select between either the normal mode circuitry (represented by solid lines) exclusively, or the additional functionality contributed by the LAI mode circuitry (represented by dashed lines). The southbound in signals and the northbound out signals are also buffered by buffers B.

The retiming circuit 234 of the southbound data path retransmits data destined for DIMMs to the south. The retiming/merge circuit 244 of the northbound data path performs a similar task for northbound data, but in the normal mode it must also interleave data from the DRAM devices into the northbound data stream. Both the southbound and northbound data path have a demux/deskew circuit 232 and 242, respectively. In normal mode and in LAI mode, these circuits select the appropriate channels of the northbound and southbound data streams. The northbound delay pipeline 240 and the southbound delay pipeline 230 also demultiplex the channel information to slow the data transfer rate for output to the attached logic analyzer during LAI mode.

In LAI mode, the control/status register 200 is accessed by the SMB bus to set modes and parameters for all MMB modes, including LAI features. In turn, the Events Selection & Response logic 210 and the Protocol Unwrapping & Pattern Recognition logic 220 are controlled by the control/status register 200. Logic 210 and logic 220 derive the TRIG, FRAME, EV, and QUAL signals that were discussed above with respect to FIG. 5, and with the exception of the EV signals, pass thee signals to the logic analyzer through the select circuit 250. The EV signals are shared among other MMBs 147 when multiple LAIs 175 are present.

An important point illustrated by FIG. 6 is that the additional features needed for the MMB 147 operating in LAI mode may all reside in what would otherwise be empty space for MMBs 146 operating in normal mode. In other words, memory module buffers may have LAI functionality “built-in” along with the normal mode functionality, and then programmed or fused so that they operate either as a memory module buffer in normal (DRAM buffer) mode (such as MMB 146) or in LAI mode (such as MMB 147). This eliminates the need to rebuild the component for validation purposes when a “normal (DRAM buffer) mode” memory module buffer already exists. Furthermore, those having skill in the art will recognize that there are many other useful derived logic functions that could be implemented and provided to the logic analyzer other than the ones described above.

FIG. 7 is a perspective diagram illustrating a physical embodiment of a Logic Analyzer Interface (LAI) according to some embodiments of the invention. In these embodiments, a host 110 (shown with heat sink 270 attached) and eight sockets 160 are mounted on a circuit board 250. The LAI 175 is attached to the second socket 160 from the host 110. The other sockets 160 each hold DIMMs with MMBs 146. In these embodiments, the interposed DIMM 120 is attached to a connector 161 that is piggybacked in-line with the socket 160 that attaches the LAI 175 to the circuit board 250. Although the connection is obscured by the LAI 175, a ribbon cable 260 attaches the LAI 175 to a logic analyzer (not shown). Like the embodiments illustrated in FIG. 4, the MMB 147 operates in LAI mode while the MMBs 146 operate in normal (DRAM buffer) mode during operation of the logic analyzer interface 175.

Having described some embodiments of the invention, several contemplated examples of tasks that the LAI 175 could perform will be described below. This description does not limit embodiments of the invention to only those tasks, as it will be recognized by those of skill in the art that there are other tasks that embodiments of the invention are particularly well-suited for.

In a link protocol validation/debug scenario, the LAI 175 may capture traces of buffered memory module links that are performing simple to complex operations. The traces are used to debug low level link protocol/operations, such as link initialization, retraining, power transitions, resets, and error recovery. For this purpose the host 110 would usually initiate traffic as a result of diagnostic or focus test software execution, rather than operating system/application activity, since this would allow specific behaviors to be produced repeatedly and without significant interference due to other link activity. Analysis of the traces could be primarily manual, since it is expected to be fairly simple, although automated checkers could also be employed to check rigorously for protocol flaws.

In a system initialization/debug scenario, the captured traces would be used to debug/validate the BIOS (basic input/output system) configuration of MMB register write and read sequences as part of system initialization. Other software configurations could be debugged/validated as well.

In a host memory controller logic interaction with DRAM scenario, traces of either tests or normal execution would be captured to enable debug of DRAM control sightings where the memory controller and/or buffer exhibit unexpected or failing behavior during complex controller/buffer/DRAM interactions. MMB traffic would reveal the exact sequences and timing of interactions as basis for manual analysis in determining root cause of the faults.

In a system level debug scenario, traces of MMB traffic under normal operating system and application execution might reveal important clues about misbehavior of logic elsewhere in the system. In this case the interaction across the MMBs and interaction with the DRAMs all work flawlessly, but the content and/or sequencing of the traffic on the link can be used to provide indirect observability of system logic behavior.

In a logic dump mode, the host 110 would remove the port attached to the LAI 175 through the socket 160 from normal usage and instead pass selected internal logic values across the port specifically so they could be captured using the LAI. This would allow high bandwidth debug signals to be traced without adding dedicated debug bus pins to the memory control chip.

One of ordinary skill in the art will recognize that the concepts taught herein can be tailored to a particular application in many other advantageous ways. In particular, those skilled in the art will recognize that the illustrated embodiments are but one of many alternative implementations that will become apparent upon reading this disclosure. For instance, a wide variety of memory tests may be envisioned using the concepts disclosed herein, only a few of which are discussed specifically herein. The particular test sequence or sequences initiated using an embodiment is important from a testing viewpoint, but all such tests can be performed within the scope of the appended claims.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

Many of the specific features shown herein are design choices. Channel and bus widths, signaling frequencies, transfer rates, the number and type of memory modules, the number and type of memory chips on a memory module, control bus protocols, etc., are all merely presented as examples. For instance, memory modules can have multiple ranks of memory and/or multiple stacks of memory. Likewise, functionality shown embodied in a single integrated circuit or functional block may be implemented using multiple cooperating circuits or blocks, or vice versa. Such minor modifications are encompassed within the embodiments of the invention, and are intended to fall within the scope of the appended claims.

1. A method comprising:
coupling a logic analyzer interface (LAI) having a first buffer to a buffered memory system;
coupling a first buffered memory module having a second buffer to the LAI; and
analyzing data traffic between the second buffer operating in a normal mode and a component of the buffered memory system using the first buffer operating in an LAI mode.

2. The method of claim 1, wherein analyzing data traffic using the first buffer operating in the LAI mode comprises:
delaying the data traffic; and
transmitting the data traffic to a logic analyzer at a reduced data transfer rate.

3. The method of claim 2, wherein analyzing data traffic using the first buffer operating in the LAI mode further comprises:
analyzing the data traffic onboard the first buffer to generate a derived signal; and
transmitting the derived signal to the logic analyzer.

4. The method of claim 1, wherein analyzing data traffic between the second buffer operating in a normal mode and the component of the buffered memory system comprises:
analyzing data traffic between the second buffer and a host.

5. The method of claim 1, wherein analyzing data traffic between the second buffer operating in a normal mode and a component of the buffered memory system comprises:
analyzing data traffic between the second buffer and a third buffer operating in the normal mode on a second buffered memory module.

6. The method of claim 5, wherein the first and second buffered memory modules are dual inline memory modules each having a plurality of memory chips.

7. The method of claim 6, wherein the plurality of memory chips comprise a plurality of DRAM devices.

8. The method of claim 1, further comprising:
capturing data traffic with the first buffer operating in the LAI mode and retransmitting the data to the second buffer operating in the normal mode and the component of the buffered memory subsystem.

9. The method of claim 1, wherein analyzing data traffic comprises analyzing northbound data traffic and southbound data traffic.

10. The method of claim 1, further comprising:
coupling a second logic analyzer interface (LAI) having a third buffer to the buffered memory system;
coupling a third buffered memory module having a fourth buffer to the second LAI; and
analyzing data traffic between the fourth buffer operating in the normal mode and a component of the buffered memory subsystem using the third buffer operating in the LAI mode.

11. An apparatus comprising:
a first connector configured to couple to a first memory module having a first buffer;
a second connector configured to couple to a logic analyzer probe;
a third connector configured to couple to a memory system, the memory system including a host and a second memory module having a second buffer; and
a third buffer configured to run in a logic analyzer interface mode when the first and second buffers are running in a normal mode.

12. The apparatus of claim 11, wherein the third buffer comprises:
first circuitry configured to capture and retransmit data traffic; and
second circuitry configured to analyze data traffic and configured to provide a derived signal based on the analyzed data traffic to the logic analyzer probe.

13. The apparatus of claim 12, wherein the first circuitry is configured to transmit the data traffic to the logic analyzer probe at a reduced data transfer rate.

14. The apparatus of claim 12, wherein the data traffic comprises:
southbound data traffic moving in a direction from the host to the first buffer, and
northbound data traffic moving in a direction from the first buffer to the host.

15. The apparatus of claim 12, wherein the first buffer comprises:
first circuitry and second circuitry, wherein the second circuitry is disabled through a fusing process.

16. The apparatus of claim 11, wherein the first and the second memory modules are selected from the group consisting of dual inline memory modules and single inline memory modules.

17. An apparatus comprising:
an output interface;
a memory module interface configured to connect to a first buffered memory module;
a buffer configured to capture data traffic in a memory system that includes a host and a second buffered memory module, configured to retransmit the data traffic to the first buffered memory module at a first transfer rate, and configured to retransmit the data traffic to the output interface at a second transfer rate.

18. The apparatus of claim 17, wherein the output interface comprises:
a socket configured to accept a logic probe.

19. The apparatus of claim 17, wherein the first transfer rate is greater than the second transfer rate.

20. The apparatus of claim 17, wherein the data traffic comprises:
northbound data traffic moving in a direction towards the host; and
southbound data traffic moving in a direction towards the second buffered memory module.

21. The apparatus of claim 17, wherein the buffer further comprises:
a circuit configured to analyze the data traffic and provide a signal derived from analyzed data traffic to the output interface.

22. The apparatus of claim 17, further comprising:
a memory system interface configured to couple the buffer to the memory system.

23. The apparatus of claim 22, wherein the memory system interface is a card edge connector.
